(19) United States
(12) Patent Application Publication
(10) Pub. No.: US 2010/0180288 A1
(43) Pub. Date: Jul. 15, 2010

(54) DISC DEVICE

(76) Inventors: Takaharu Eguchi, Tokyo (JP); Yoshifumi Awakura, Tokyo (JP); Daisuke Morimoto, Tokyo (JP); Tatsunori Fujiwara, Tokyo (JP)

Correspondence Address: BIRCH STEWART KOLASCH & BIRCH, PO BOX 747, FALLS CHURCH, VA, 22040-0747, US

(21) Appl. No.: 12/667,636

(22) PCT Filed: Jun. 5, 2008
(86) PCT No.: PCT/JP2008/001441

§ 371 Date: Jan. 4, 2010

(30) Foreign Application Priority Data
Sep. 28, 2007 (JP) 2007-255011

(51) Int. Cl. G11B 17/04

(52) U.S. Cl. 720/621; G9B/17.013

(57) ABSTRACT

A disc device includes a conveying roller and a disc guide which are disposed in such a way as to be able to move upwardly and downwardly with respect to a main unit thereof, and a moving unit for downwardly moving said conveying roller and said disc guide by different amounts of travel respectively in synchronization with a downward movement of an inserted disc and placement of the disc on a turntable.

### FIELD OF THE INVENTION

The present invention relates to a disc device that, while pressing a disc against a disc guide with a conveying roller, inserts the disc into a main unit thereof and ejects the disc from the main unit by rotation of the conveying roller.

### BACKGROUND OF THE INVENTION

In a conventional disc device, a disc guide is fixed to a main unit of the disc device, and a disc conveying roller inserts a disc into the main unit and ejects the disc from the main unit by rotation of the conveying roller while pressing the disc against the disc guide. After a disc is carried to a predetermined position in the main unit, the disc goes away from the disc guide and is then placed on a turntable while the conveying roller moves in a direction of largely going away from the disc and the disc device is placed in a playback state. As a result, although a clearance for vibrations is ensured between the disc and the disc guide and between the disc and the conveying roller, the shape of the device is upsized to ensure this clearance.

Therefore, in recent years, as shown in, for example, patent reference 1, in order to achieve a downsizing of device shape, the sharing of the same motor for disc conveyance and for playback head movement has been advanced, and devices in which a playback unit is provided with a disc conveying mechanism and therefore a disc guide is fixed and installed in the playback unit have become numerous. However, in this disc playback apparatus, a clearance 23 has to be created between the main unit 21 and the playback unit 22 in a playback state in order to take measures against vibrations, as shown in FIG. 12(a). Therefore, when the disc playback apparatus is in a state in which it is conveying a disc, the disc playback apparatus has to move a disc conveying unit to a position to which the disc has been inserted. Furthermore, the disc playback apparatus has to raise the whole playback unit as shown in FIG. 12(b), or has to raise one side portion of the playback unit 22 as shown in FIG. 12(c).

Because the disc playback apparatus maintains this state when the disc playback apparatus is waiting for insertion of a disc, a stress load is permanently exerted upon dampers 25 each for elastically holding of a pin 24 disposed in the playback unit 22, and each of the dampers 25 may become deformed under the influence of temperature and so on. As a result, the vibration absorption performance of the damper at the time of occurrence of vibrations varies, and the vibration performance of the device degrades. Furthermore, although it is possible to reduce the clearance 23 at the time of playback in order to reduce the amount of deformation of each of the dampers 25, in this case, the stroke of vibration absorption decreases due to the reduction in the clearance 23, and the vibration performance of the device becomes low in its initial stage. In addition, because each of the dampers 25 becomes deformed at the time of making a mode transition from the disc playback state to the disc conveying state, the load at the time of the mode transition becomes large and a load is placed on power system parts, such as the motor.

[Patent reference 1] JP, 2004-206871, A

As mentioned above, in a conventional disc device that shares the same motor for disc conveyance and for playback head movement, because a position to which a disc is inserted is not varied with respect to the main unit of the disc device and is located above the center of the device, the playback unit is fixed and on standby in a state in which its disc insertion opening is oriented upwardly. The conventional disc device can be alternatively constructed in such a way that the playback unit is fixed as level as possible by reducing the clearance at the time of playback. Therefore, the dampers for absorbing a shock caused by extraneous vibrations become deformed and the damper property of the device is lost, or degradation in the vibration performance of the device is caused due to a shortage of the clearance. A further problem is that because a disc is inserted into or ejected from a conventional disc device while dampers are made to become deformed, an excessive action load occurs in the disc device.

The present invention is made to solve the above-mentioned problems, and it is therefore an object of the present invention to provide a disc device that prevents dampers for vibration isolation disposed between a disc guide and a main unit from becoming deformed, thereby being able to reduce the action load on the disc device and acquire an adequate vibration isolation stroke.

### DISCLOSURE OF THE INVENTION

A disc device in accordance with the present invention includes a conveying roller and a disc guide which are disposed in such a way as to be able to move upwardly and downwardly with respect to a main unit thereof, and a moving unit for downwardly moving the above-mentioned conveying roller and the above-mentioned disc guide by different amounts of travel respectively in synchronization with a movement of an inserted disc in a vertical direction and placement of the disc on a turntable.

Because the disc device in accordance with the present invention is constructed in such a way as to downwardly move the conveying roller and the disc guide by different amounts of travel respectively in synchronization with a downward movement of an inserted disc and placement of the disc on the turntable, an adequate vibration isolation stroke can be provided between the above-mentioned conveying roller and the above-mentioned disc guide, and the main unit. Furthermore, there is provided another advantage of being able to reduce the clearance between a playback unit and the main unit and place the playback unit in a horizontal position, and prevent a one-sided pressure from being exerted upon an impact-absorbing damper for holding the playback unit with respect to the main unit to prevent the damper from becoming deformed.

### BRIEF DESCRIPTION OF THE FIGURES

FIG. 1 is an exploded perspective view of a disc playback apparatus in accordance with Embodiment 1 of the present invention;

FIG. 2 is a perspective view showing a playback unit;

FIG. 3 is a perspective view showing a state of insertion of a disc in to the playback unit;

FIG. 4 is a side view of FIG. 3;

FIG. 5 is a side view showing a state in which a sliding plate is detached in FIG. 4;

FIG. 6 is a side view showing only a main part of FIG. 4;

FIG. 7 is a plan view showing the playback unit in a state in which the insertion of the disc is completed;

FIG. 8 is a side view of FIG. 7;

FIG. 9 is a side view showing a state in which a sliding plate is detached in FIG. 7;

FIG. 10 is a side view showing only a main part of FIG. 7;

FIG. 11 is a front view of the sliding plate when viewed from the inside of the device along the A-A line of FIG. 3; and

FIG. 12 is an outline diagram showing a positional relationship between a playback unit and a chassis in a conventional device.

### PREFERRED EMBODIMENTS OF THE INVENTION

Hereafter, in order to explain this invention in greater detail, the preferred embodiments of the present invention will be described with reference to the accompanying drawings.

### Embodiment 1

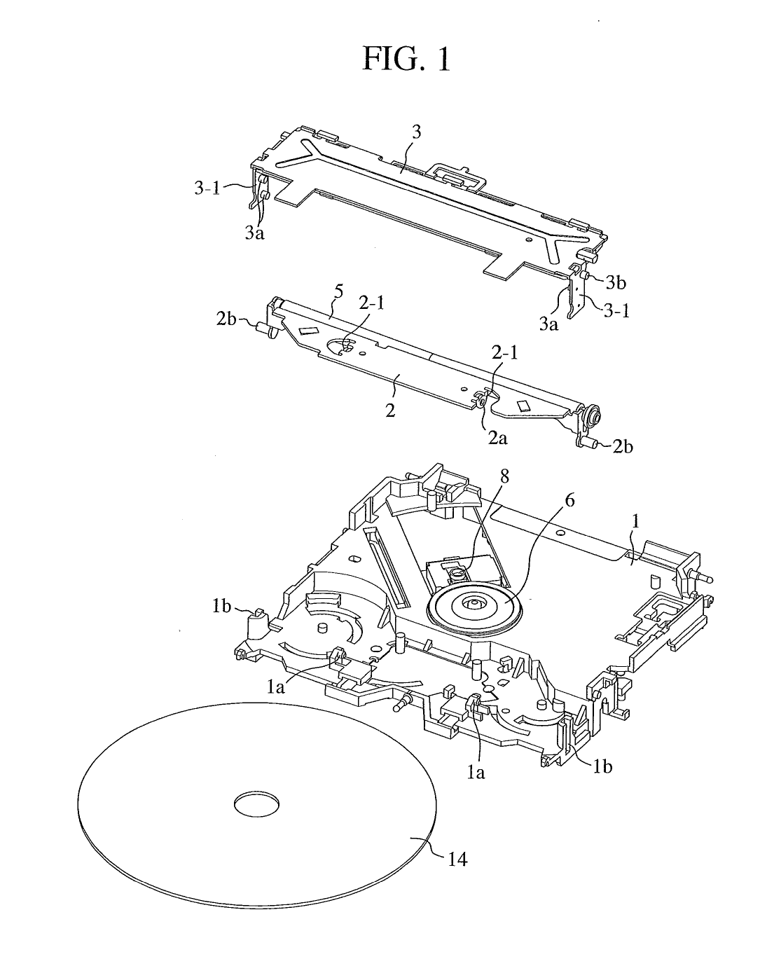

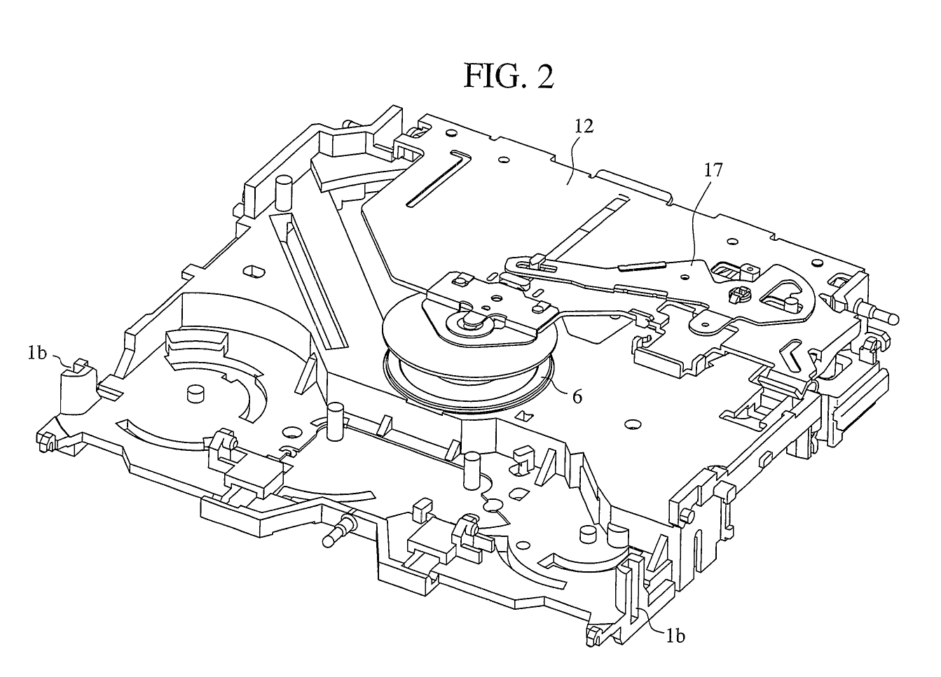

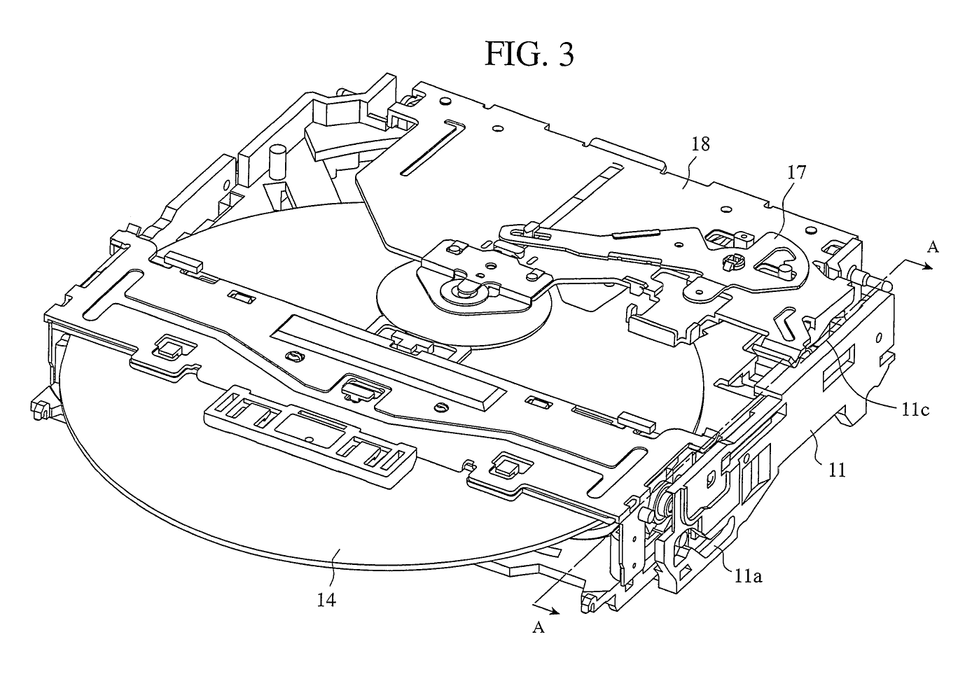

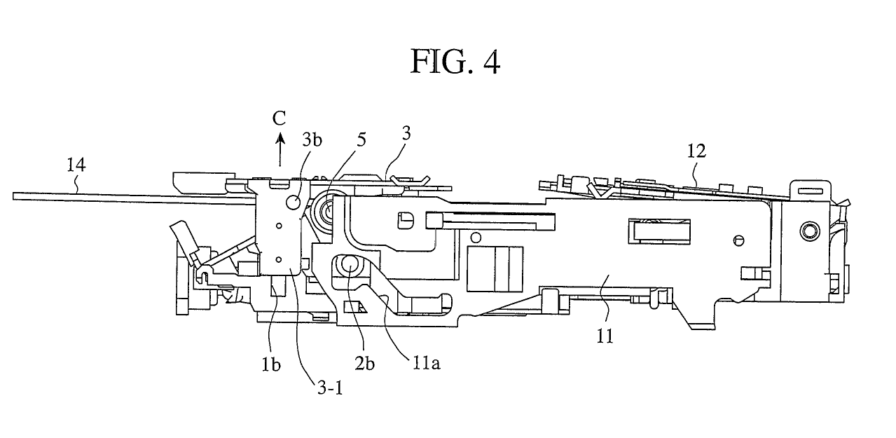

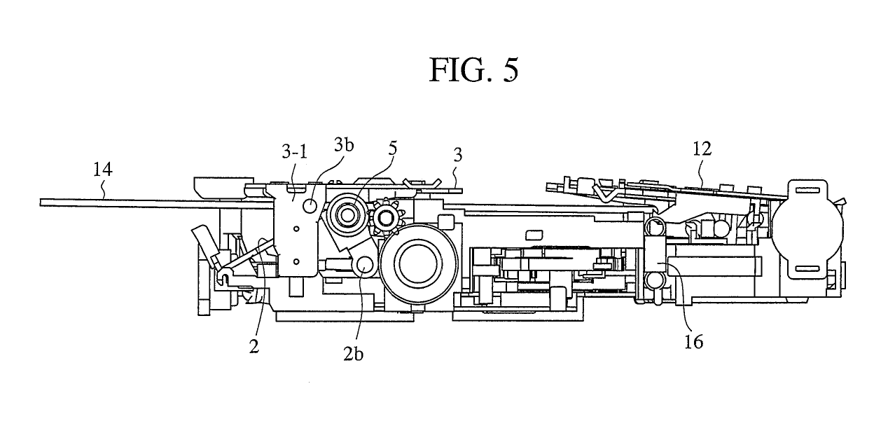

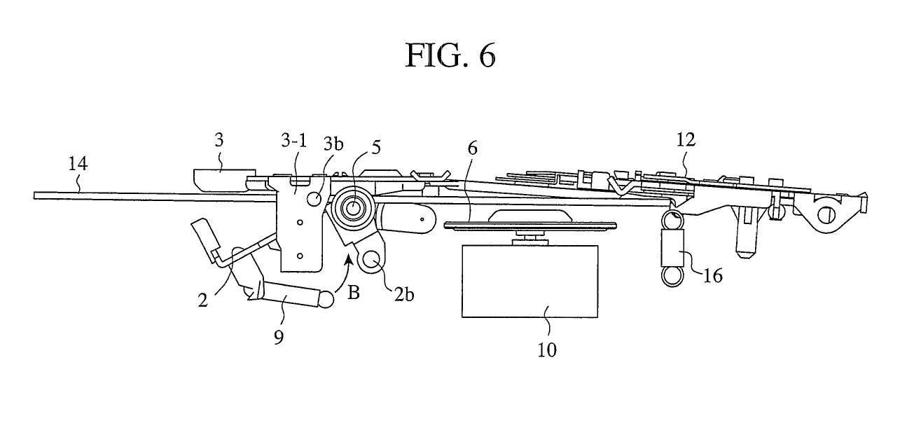

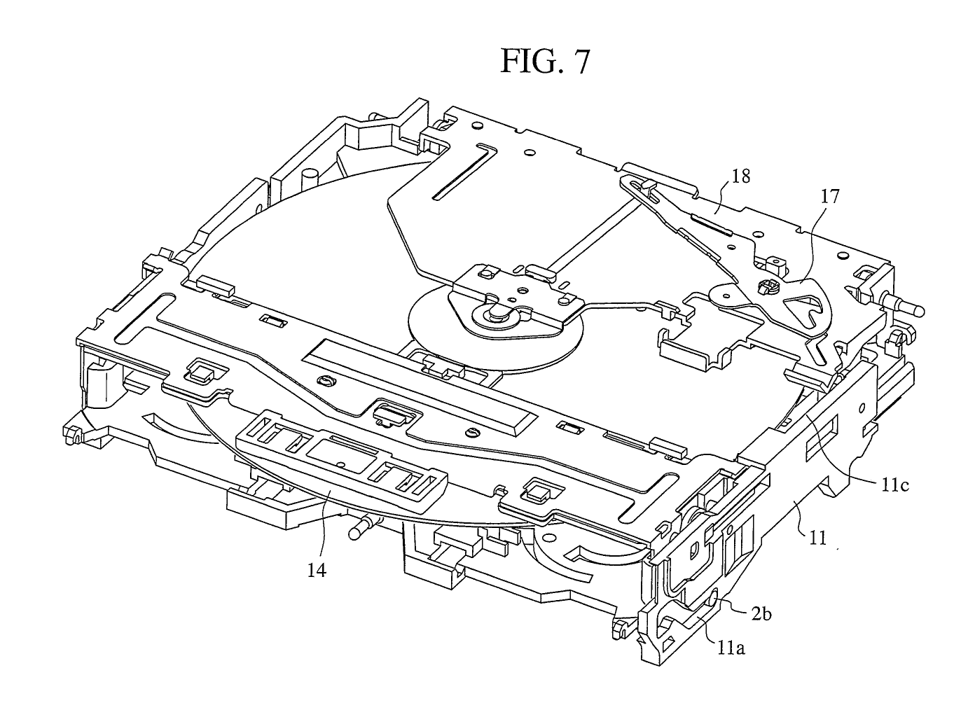

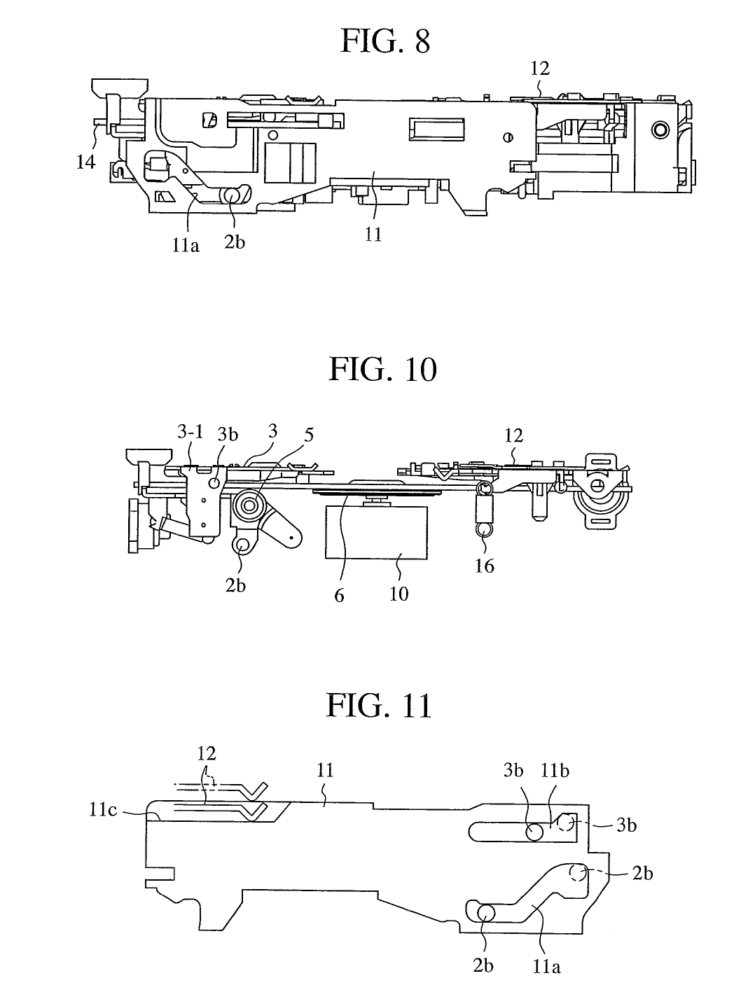

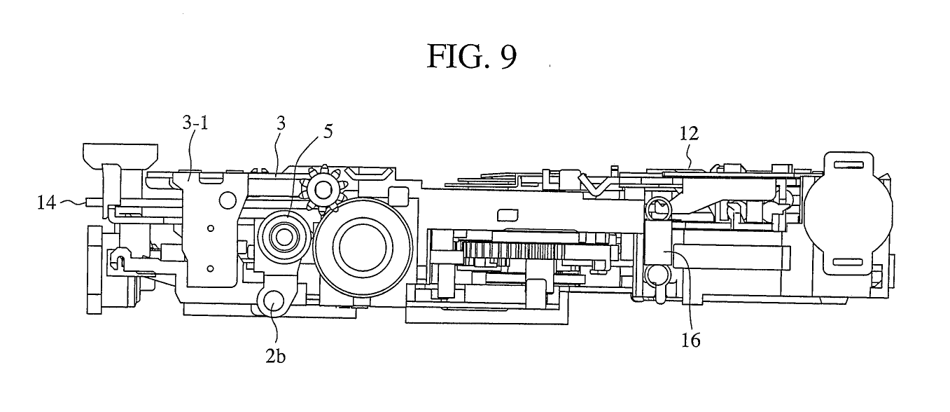

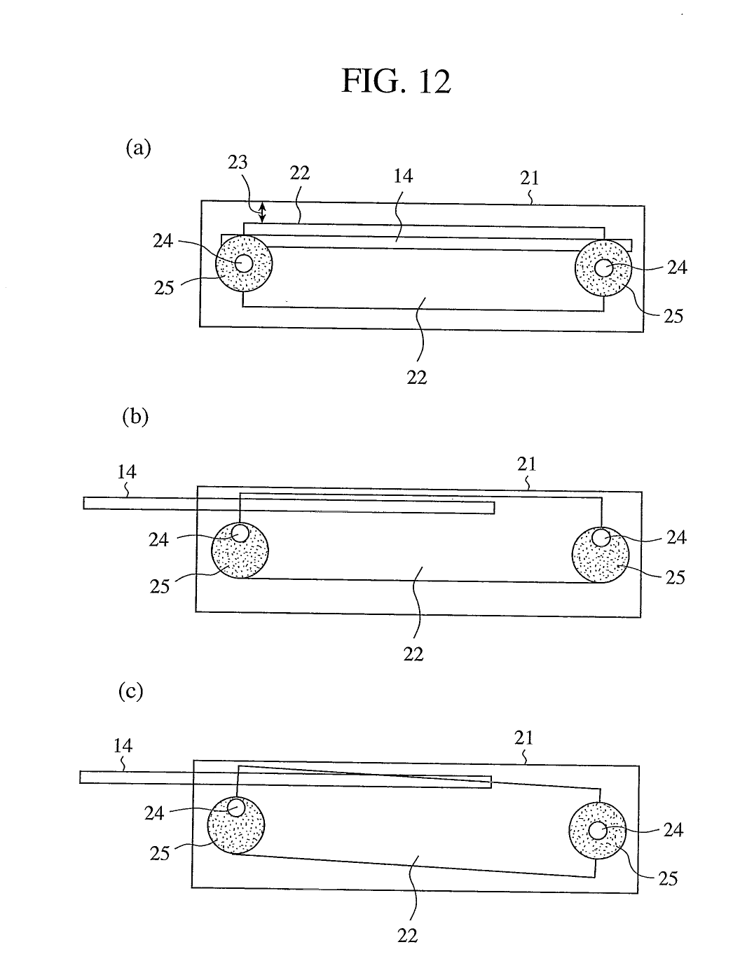

FIG. 1 is an exploded perspective view of a disc playback apparatus in accordance with Embodiment 1 of the present invention, FIG. 2 is a perspective view showing a playback unit, FIG. 3 is a perspective view showing a state of insertion of a disc into the playback unit, FIG. 4 is a side view of FIG. 3, FIG. 5 is a side view showing a state in which sliding plates are detached in FIG. 4, FIG. 6 is a side view showing only a main part of FIG. 4, FIG. 7 is a plan view showing the playback unit in a state in which the insertion of the disc is completed, FIG. 8 is a side view of FIG. 7, FIG. 9 is a side view showing a state in which the sliding plates are detached in FIG. 7, FIG. 10 is a side view showing only a main part of FIG. 7, and FIG. 11 is a front view of one of the sliding plates when viewed from the inside of the device along the A-A line of FIG. 3.

In the figures, both ends of a roller (a disc conveying roller) 5 are rotatably supported by a roller supporting member 2, and is always pressed by a spring 9 in such a way as to be in contact with a rear surface of a disc guide 3 (refer to FIG. 6). By fitting supporting axes 1a and 1a disposed on both sides on a chassis 1, which is provided as a main unit, into attachment holes (one of which is shown in a portion of FIG. 1 which is partially cut out) 2a respectively formed in a pair of right and left portions 2-1 and 2-2 which are cut and raised from the rear surface of the plate-shaped roller supporting member 2, the roller supporting member 2 is rotatably attached to the chassis 1. Furthermore, the roller supporting member 2 has pins 2b on left and right sides thereof, the pins 2b being respectively brought into contact with cam grooves 11a (refer to FIG. 11) for conveying roller movement which are respectively formed in sliding plates 11 disposed on both sides of the chassis 1.

The disc guide 3 has downwardly-extending guide portions 3-1 and 3-1 on both sides thereof. By respectively inserting pins 3a and 3a formed on inner surfaces of these guide portions 3-1 and 3-1 into grooves 1b formed on left and right sides of the chassis 1 and extending in a vertical direction, the disc guide 3 is attached to the chassis in such a way as to be able to move upwardly and downwardly. Furthermore, pins 3b and 3b (one of the pins on a left-hand side is not shown) which are brought into contact with cam grooves 11b (refer to FIG. 11) for disc guide movement which are formed in the sliding plates 11 (refer to FIG. 3) are formed on outer surfaces of the guide portion 3-1 and 3-1, respectively. In a central portion of the chassis 1, a turntable 6 for fixing the disc 14 at the center thereof, a spindle motor 10 for rotating this turntable 6, and an optical pickup 8 for reading a signal recorded in the disc 14 are disposed.

The sliding plates 11 are respectively disposed on the both side surfaces (in FIG. 3, only one of them is shown) of the chassis 1 in such a way as to be able to move in forward and backward directions, as shown in FIG. 3, and the cam groove 11a for conveying roller movement and the cam groove 11b for disc guide movement are formed in a front portion of each of the inner surfaces of the sliding plates 11, as shown in FIG. 11. Furthermore, a cut-out portion 11c for removing a restriction on a clamp member 12 is formed in a rear upper portion of each of the sliding plates, and, when this cut-out portion 11c reaches a position corresponding to that of the clamp member 12, the clamp member 12 is rotated toward the upper side of the turntable 6 by a pressing force from a pressing member 16 and presses the disc 14 against the turntable to clamp the disc.

In this case, the sliding plates 11, the cam groove 11b for disc guide movement and the cam groove 11a for conveying roller movement which are formed in each of the above-mentioned sliding plates 11, the pins 3b and 3b disposed on the disc guide 3 and acting on the above-mentioned cam grooves 11b for disc guide movement, and the pins 2b disposed on the conveying roller attaching member 2 and acting on the above-mentioned cam grooves 11a for conveying roller movement construct a moving unit for downwardly moving the conveying roller 5 and the above-mentioned disc guide 3 by different amounts of travel respectively.

Next, the operation of the disc device will be explained.

When the disc device is on standby to wait for insertion of a disc 14 and while a disc 14 is inserted and carried, the roller supporting member 2 is rotated about the supporting axes 1a (refer to FIG. 1) in a direction shown by an arrow B and is pressed toward the direction, as shown in FIGS. 3 to 6, and the conveying roller 5 is pressed against the rear surface of the disc guide 3. Furthermore, the disc guide 3 is pushed up by the conveying roller 5, and is moved upwardly (in a direction shown by an arrow C) along the grooves 1b and is located at a certain position (refer to FIG. 1). When a disc 14 is inserted in this state, a not-shown detecting member detects this insertion and then closes a switch for a not-shown motor circuit, and the driving force of this motor rotates the conveying roller 5 to carry the disc 14 toward the inside of the device with the roller while sandwiching the disc 14 between the conveying roller 5 and the disc guide 3.

As shown in FIG. 7, when the central part of the disc 14 reaches above the turntable 6, the sliding plates 11 slide toward the front side of the main unit in synchronization with a movement of a lever 17 (refer to FIGS. 2 and 3) which is pushed and moved by the inserted disc. According to this movement of the sliding plates 11, the clamp member 18 whose downward rotation has been restricted on the upper surfaces of these sliding plates 11 is positioned at a position corresponding to the cut-out portions 11c formed in the upper portions of the sliding plates 11, and the restriction is then removed. As a result, the clamp member 18 is rotated downwardly by the pressing force of the pressing member 16, and, as shown in FIGS. 8 to 10, presses the disc 14 against the turntable 6 to hold the disc.

At this time, as the sliding plates 11 move, the roller supporting member 2 receives a rotational force through the cam grooves 11a for conveying roller movement and is therefore moved downwardly, while the disc guide 3 receives a rotational force through the cam grooves 11b for disc guide movement and is therefore moved downwardly by an amount of travel different from that by which the roller supporting member 2 is moved. As a result, the disc guide 3 is moved horizontally through a distance which is equal to the gap between the pin 3a and the groove 1b.

In this case, the conveying roller 5 and the above-mentioned disc guide 3 are moved downwardly by the different amounts of travel respectively according to the difference in shape between the cam grooves 11a for conveying roller movement and the cam grooves 11b for disc guide movement. As a result, a clearance is created between the chassis 1 and the disc guide 3, between the disc guide 3 and the disc 14, and between the disc 14 and the conveying roller 5, and vibration isolation between the chassis 1 and the disc guide 3 is ensured. Furthermore, the disc 14 is prevented from being in contact with the disc guide 3 and the conveying roller 5 at the time of playback between the disc guide 3 and the disc 14 and between the disc 14 and the conveying roller 5.

As mentioned above, because the disc device in accordance with this Embodiment is constructed in such a way that the disc guide 3 can be moved in the upward and downward directions and in the horizontal direction, the disc device can insert and eject the disc thereinto and therefrom while keeping the playback unit, i.e., the chassis level within the main unit. Furthermore, this Embodiment provides an advantage of being able to ensure adequate vibration isolation with the clearance created between the chassis 1 and the disc guide 3 which is moved downwardly in the playback state.

Furthermore, because the disc device is constructed in such a way that the pins disposed on the disc guide and the pins disposed on the conveying roller attaching member act on the cam grooves formed in the slider plates respectively, the moving unit for downwardly moving the conveying roller and the above-mentioned disc guide by different amounts of travel can be provided with a brief structure and with a high degree of precision. In addition, because the disc guide is constructed in such a way that the downwardly-extending guide portions formed on the both sides thereof act on the guide portions disposed on the both side surfaces of the main unit, the disc guide can be moved upwardly and downwardly with stability.

### INDUSTRIAL APPLICABILITY

As mentioned above, the disc device in accordance with the present invention is constructed in such a way as to downwardly move the conveying roller and the disc guide by different amounts of travel in synchronization with placement of an inserted disc on the turntable, thereby being able to provide an adequate vibration isolation stroke between the disc guide and the main unit, and preventing a one-sided pressure from being exerted upon an impact-absorbing damper for holding the playback unit with respect to the main unit to prevent the damper from becoming deformed. Therefore, the disc device in accordance with the present invention is suitable for use as a small vehicle-mounted disc playback apparatus and so on which are placed in an environment in which a vibration or the like easily occurs.

1. A disc device that, while pressing a disc against a disc guide with a conveying roller, inserts the disc into a main unit thereof and ejects the disc from the main unit by rotation of the conveying roller, characterized in that said conveying roller and said disc guide are disposed in such a way as to be able to move upwardly and downwardly with respect to said main unit, and said disc device includes a moving unit for downwardly moving said conveying roller and said disc guide by different amounts of travel respectively in synchronization with a downward movement of the inserted disc and placement of the disc on a turntable, and, at a time of waiting for insertion of a disc or inserting and carrying a disc, moves said conveying roller and said disc guide in an upward direction.

2. The disc device according to claim 1, characterized in that the moving unit is comprised of a sliding plate that is made to move toward a front side of the main unit when the disc is inserted to a predetermined position, a cam groove for disc guide movement and a cam groove for conveying roller movement formed in said sliding plate, a pin that is disposed on the disc guide and acts on said cam groove for disc guide movement, and a pin that is disposed on a conveying roller attaching member and acts on said cam groove for conveying roller movement.

3. The disc device according to claim 1, characterized in that the disc guide has a downwardly-extending guide portion formed on each of both sides thereof, and each of both side surfaces of the main unit has a guide portion for guiding said guide portion along a vertical direction.
